(19) United States
(12) Patent Application Publication
(10) Pub. No.: US 2016/0009055 A1
(43) Pub. Date: Jan. 14, 2016

(54) DEVICE AND METHOD FOR REPAIRING A TEXTURED SURFACE

(71) Applicant: Frank Spadaro, Boca Raton, FL (US)

(72) Inventor: Frank Spadaro, Boca Raton, FL (US)

(21) Appl. No.: 14/328,161

(22) Filed: Jul. 10, 2014

(51) Int. Cl. B32B 7/06; C09J 7/02; B32B 3/08; B32B 37/18; B32B 37/12

(52) U.S. Cl. CPC B32B 7/06; B32B 37/18; B32B 37/1284; B32B 3/085; C09J 7/0207; C09J 7/0267; B32B 2556/00; B32B 2405/00; C09J 2201/122; C09J 2201/16; C09J 2201/606; C09J 2425/006

(57) ABSTRACT

A method and device for repairing a textured surface is disclosed. In one embodiment, the device is a patch that includes a backing for receiving a top portion. The backing has a top surface opposing a bottom surface. The top portion includes a plurality of substantially spherical and popcorn shaped bodies attached to and extending perpendicularly from the top surface of the backing. The plurality of bodies and top surface of the backing define a pattern matching the textured surface. The patch further includes an adhesive layer on the bottom surface of the backing and a removably attached liner covering the adhesive layer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to textured surfaces, and more specifically to repairing textured surfaces.

### BACKGROUND

Textured surfaces are used in the construction industry for walls, ceilings and other surfaces. A popcorn ceiling, also known as cottage cheese ceiling or more accurately a Stucco ceiling, is a term for a spray-on or paint-on ceiling treatment used since the late 1950s in residential construction.

In some situations to create a textured surface, a separate textured layer is applied to an interior or external surface, often prior to painting. The textured layer is typically formed by spraying texture material onto the surface. Texture material is a coating material that, when sprayed, does not form a smooth, thin coating. Instead, texture material is applied in or contains discrete drops, globs, or particles that dry to form a bumpy, irregular textured surface.

Texture materials can be applied using any one of a number of application systems. During new construction, texture materials are commonly applied in a stream of compressed air using commercial hopper gun systems. Varying the parameters of the application system varies the size and spacing of the bumps to vary the look of the textured surface.

The textured surfaces may become damaged due to water, mechanical forces or for other reasons. When such damage occurs the surfaces can be repaired. There are a variety of problems associated with the repair of textured surfaces.

Conventional means of pairing textured surfaces include using an aerosol system to dispense textured material. However, such systems dispense material that has an appearance much different than the existing non-damaged surface. Additionally, the aerosol sprays can be inaccurate. As a result, the sprays can affect surface areas that do not require repairing. Furthermore, use of such inaccurate aerosol sprays is not cost effective as many times more spray is used as is actually needed to repair the damaged surface area.

Therefore, a need exists for improvements over the prior art, and more particularly for methods and a device that more effectively repairs textured surfaces, ceilings and walls. There is a need for a more accurate and cost effective way of repairing damaged textured surfaces. Additionally, there is also a need for a way to repair a damaged ceiling so that the repaired section more closely resembles the existing non-damaged surface.

### SUMMARY

A device and method for repairing textured surfaces is disclosed. This Summary is provided to introduce a selection of disclosed concepts in a simplified form that are further described below in the Detailed Description including the drawings provided. This Summary is not intended to identify key or essential features of the claimed subject matter. Nor is this Summary intended to be used to limit the claimed subject matter's scope.

In one embodiment, the invention is a patch for repairing a textured surface. The patch includes a backing for receiving a top portion. The backing has a top surface opposing a bottom surface. The top portion includes a plurality of substantially spherical and popcorn shaped bodies attached to and extending perpendicularly from the top surface of the backing. The plurality of bodies and top surface of the backing define a pattern matching the textured surface. The patch further includes an adhesive layer on the bottom surface of the backing and a removably attached liner covering the adhesive layer.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left most digit of a reference number identifies the drawing in which the reference number first appears. The accompanying drawings, which are incorporated in and constitute a part of this disclosure, illustrate various example embodiments. In the drawings:

FIG. 1 is an illustration of a perspective view of the patch, in accordance with one embodiment of the present invention;

FIG. 2 is an illustration of a cross-sectional side view of the patch, in accordance with one embodiment of the present invention;

FIG. 3 is an illustration of a cross-sectional side view of the patch attached to a textured surface, in accordance with one embodiment of the present invention;

FIG. 4 is an illustration of a perspective view of the patch, in accordance with another embodiment of the present invention; and,

FIG. 5 is an illustration of a perspective view of the patch attached to a textured surface, in accordance with one embodiment of the present invention.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods and devices described herein may be modified by substituting, reordering, or adding stages or elements to the disclosed methods or devices. Accordingly, the following detailed description does not limit the invention. Instead, the proper scope of the invention is defined by the appended claims.

In one embodiment, the present invention is a patch for repairing textured surfaces. The present invention improves over the prior art by providing a low cost alternative for repairing portions of textured surfaces. The present invention also provides a surface that more closely matches the existing non-damaged textured surfaces than the prior art. The present invention also provides a more precise and controlled way of repairing textured surfaces than the prior art. Additionally, the present invention allows for the repair of much smaller portions of textured surfaces more cost effectively than the prior art.

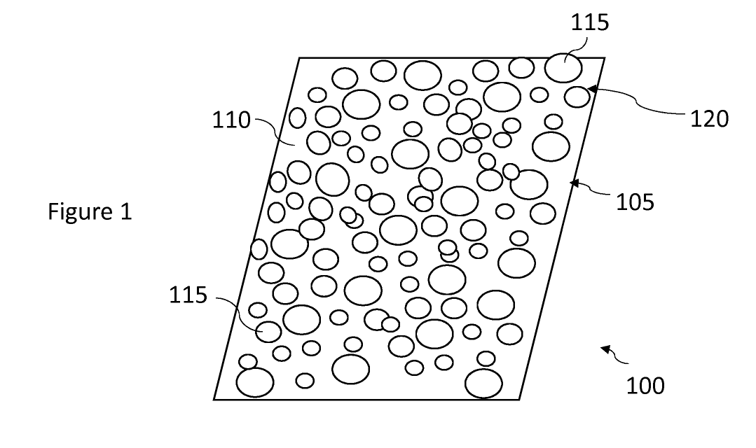

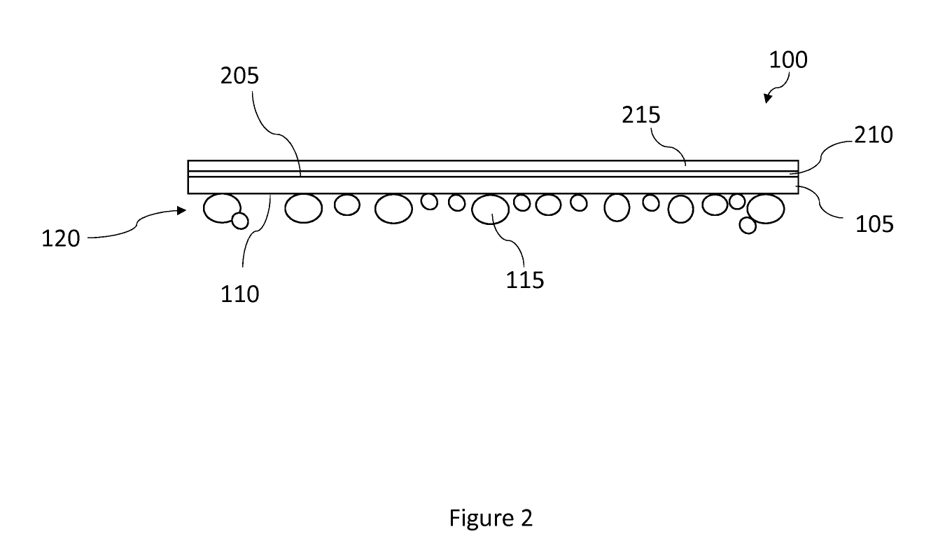

FIG. 1 illustrates a perspective view of one embodiment of a patch 100 for repairing a textured surface. The invention includes a backing 105 having a top surface 110 opposing a bottom surface 205 (shown in FIG. 2). The backing can have a planar rectangular shape and can be sized or cut to fit the size of the damaged textured surface that is being repaired. The backing may be formed from paper or vinyl. Other materials known to those skilled in the art, such as plastics or polymer sheets may be used.

A top portion 120 is attached to the top surface of the backing 105. In the present embodiment, the top portion comprises a plurality of bodies 115 extending perpendicularly from the top surface. The bodies 115 can have various shapes and sizes. In the present embodiment, the bodies define a substantially spherical and/or popcorn shape. A popcorn shape is somewhat spherical in nature having irregular textured surfaces and bumps or globs thereon. The popcorn shape is the shape of spray-on or paint-on ceiling treatment used from the late 1950s in residential construction.

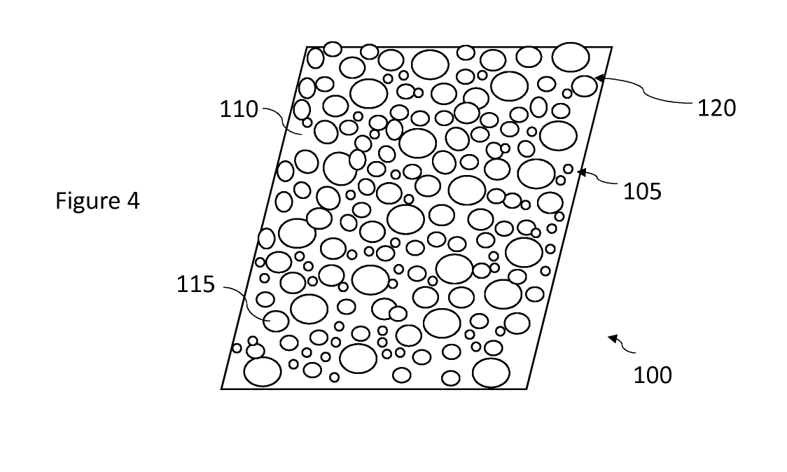

Additionally, the bodies may have various shapes such that the pattern defined by the bodies and the top surface match the textured surface that the patch will be applied to. As shown in FIG. 4, the amount of bodies per square unit area (such as cm² or m²) can be increased depending on the pattern upon which the patch is to be applied. In FIG. 4, the amount of bodies 115 per square unit area attached to the top surface 110 is greater than that of the embodiment in FIG. 1. In another embodiment (not shown), bodies may have substantially the same size and shape.

The bodies may be formed from Styrofoam, polystyrene, expanded polystyrene, foam balls, styrene, cinnamene, phenylethylene, thermacol, vinylbenzene or any other material closely resembling or matching the bodies or features of the textured surface upon which the patch is to be applied.

In another embodiment (not shown), the top portion may comprise a sheet having a plurality of bodies extending from the surface of the sheet, wherein the bodies and top surface of the sheet define a pattern similar to or matching that of the textured surface upon which the patch will be applied. In yet another embodiment (not shown), the top portion may comprise a sheet having embossed designs or features stamped on the sheet such that pattern of the design matches the design of a textured surface upon which the patch is to be applied. The sheet may also have a graphical or photographical design that matches the textured surface. The sheet may be formed from paper, plastic, vinyl etc.

The top portion 120 is attached to the backing with an adhesive suitable to adhering the bodies or sheet to the backing and is well known to those skilled in the art. The adhesive may have in ingredients, such as acrylic cement, reactive adhesive, a non-reactive adhesive, glue, epoxy etc.

FIG. 2 is an illustration of a cross-sectional side view according to one embodiment of the present invention. FIG. 2 illustrates the top portion 120, comprising a plurality of bodies having popcorn and substantially spherical shapes attached to the top surface 110 of the backing 105. Deposited on the bottom surface 205 of the backing is an adhesive layer 210. The adhesive layer 210 is used to attach the patch 100 to the desired position on the textured surface. The adhesive layer can be formed from adhesive that is well known to those skilled in the art and used to attach or adhere items to surfaces. Such adhesives may include cornice adhesive, glue, masonry adhesive, plasterboard adhesive, all purpose construction adhesive, pressure sensitive adhesive (PSA). The PSAs may comprise, acrylics, butyl rubber, ethylene-vinyl acetate, natural rubber, nitriles, silicone rubbers, and stryrene block co-polymers, Styrene-butadiene-styrene, Styrene-ethylene/butylene-styrene, Styrene-ethylene/propylene, Styrene-isoprene-styrene, and Vinyl ethers.

Covering the adhesive layer is a removably attached liner 215. The removably attached or attachable liner can comprise a material such as wax paper or paper such that the adhesive layer retains its adhesive properties and prevents the patch from being stuck somewhere unwantedly during manufacturing and transportation.

In one embodiment, the patch 100 can be made by depositing an adhesive layer 210 on to the bottom surface of the backing 105. This process is well known to those skilled in the art. In one non-limiting embodiment, a heat pressing machine may press mixtures of adhesive onto large sheets of backing. These large sheets can then be cut into the desired shape and size. In another embodiment, prefabricated sections of vinyl, paper, or plastic having pressure sensitive adhesive on the bottom surface of the sheet can be used.

Next, a removably attachable liner is applied to the pressure sensitive adhesive to cover the adhesive during transport and manufacturing. It should be noted that in certain embodiments where pre-fabricated sections of backing or sheets are used, the removably attached liner may be a component of the prefabricated section.

Next, a top portion 120 is attached to the top surface 110 of the backing. In one embodiment, the top portion comprises a plurality of popcorn and/or substantially spherically shaped bodies. To adhere the bodies to the top surface, adhesive may be spread onto the top surface before the bodies are applied. The bodies are applied such that the top surface and bodies define a pattern similar to or matching the appearance of the textured surface on which the patch is to be applied. In the alternative, adhesive may be applied to the bodies before attaching to the top surface. The adhesive may be applied by spraying the bodies with adhesive, dipping the bodies into adhesive, painting the bodies with adhesive etc. The shape, position and number of bodies per square unit area define a pattern having an appearance similar to or matching the appearance of a textured surface.

In other embodiments (not shown), the top portion may be sheets having a plurality of bodies extending perpendicularly from its surface or having an embossed design stamped onto the surface of the sheet. Similar to the other top portions, in these embodiments the patterns and designs on the top surface of the sheets resemble or match the textured surface upon which the patch is to be applied. These sheets may be attached to the backing using adhesive.

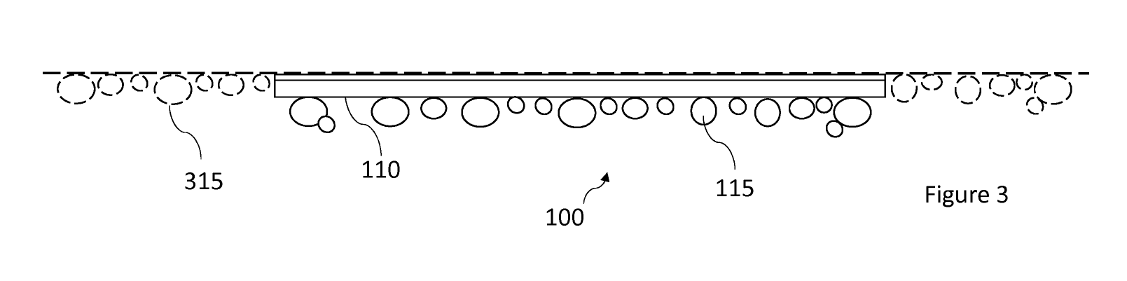

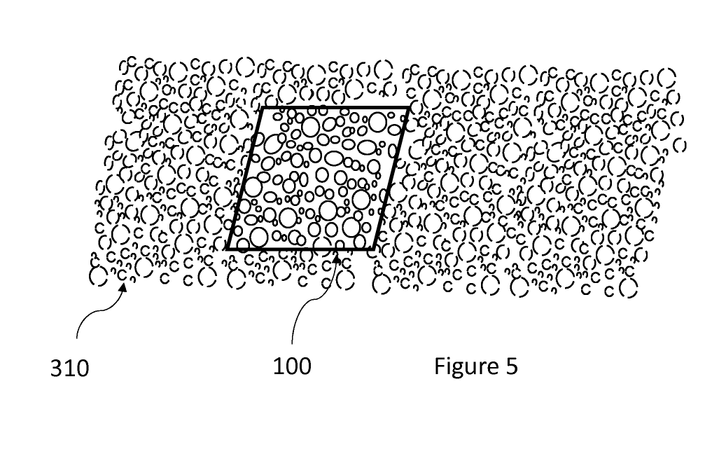

FIG. 3 illustrates a cross-sectional side view of the patch 100 applied to a textured surface 310. Prior to applying the patch to the textured surface, the area to which the patch is to be applied can be cleaned and smoothed out to provide a smooth or flat surface upon which the pressure sensitive adhesive can be pressed onto. FIGS. 3 and 5 illustrate how the patch when applied matches textured surfaces. When applied, the top portion of the patch 100 blends with and matches the textured surfaces 310. Because the patterns of the textured surface 310 and top portion 105 are similar, it is difficult for an individual to determine if an area of the surface was damaged.

FIG. 4 illustrates a perspective view of another embodiment of the patch. In FIG. 4, the amount of bodies per square unit area is greater than the amount of bodies per square unit area in FIG. 1. As a result, the patterns resulting from the top portion and top surface of the backing in FIGS. 1 and 4 are different. FIGS. 1 and 4 also illustrate how the top portions can be adjusted or formed to match different textured surfaces.

In other embodiments (not shown), the patch may be a component of a kit for repairing textured surfaces. The kit may also comprise a scraper for removing textured portions or bodies attached to the surface of textured walls and ceilings. After the textured portions of the surface have been removed, the pressure sensitive adhesive on the bottom surface of the backing can be pressed onto the smoothened surface. Additionally, the kit may also comprise a cleaning element to clean the surface where the patch is to be applied. A cleaning element, such as a cloth, rag or paper towel, may contain solvents to remove water-soluble and/or lipid-solvable debris and dirt from the area where the patch is to be applied.

To repair a textured surface, wall or ceiling, the surface to be repaired is cleaned to remove any dirt or debris. The surface can be smoothened to provide a substantially even or flat surface upon which the patch may be applied. In one embodiment, a scraper or brush may be used to flatten or smooth the area. Additionally, the patch may be cut to or sized such that the patch fits the area to which it is to be applied. Before applying the patch, the removably attached liner is removed or peeled from the pressure sensitive adhesive layer. The patch is then positioned into place over the area and pressed against the smooth surface activating the pressure sensitive adhesive layer.

The patch may be stored in various ways. For example, the patch may be cut into individual sections for various uses. In one embodiment, (not shown) the patch may be provided as a roll from which strips may be cut to a desired size and subsequently applied in a desired

1. A patch for repairing a textured surface comprising:
a backing for receiving a top portion, wherein the backing has a top surface opposing a bottom surface;
a top portion attached to the top surface of the backing;
a pressure sensitive adhesive layer deposited on the bottom surface of the backing; and,
a removably attached liner covering the adhesive layer.

2. The patch of claim 1, wherein the top portion comprises a plurality of bodies extending perpendicularly from the top surface of the backing.

3. The patch of claim 2, wherein the plurality of bodies and top surface of the backing define a pattern matching the textured surface.

4. The patch of claim 3, wherein a number of the bodies are substantially spherically shaped.

5. The patch of claim 3, wherein a number of the bodies are substantially popcorn shaped.

6. The patch of claim 2, wherein the bodies are formed from polystyrene.

7. The patch of claim 2, wherein the top portion is attached to the backing with adhesive.

8. The patch of claim 1, wherein the top portion comprises a sheet having a top surface opposing a bottom surface, wherein the top surface of the sheet has an embossed design, and wherein the design defines a pattern matching the textured surface.

9. The patch of claim 1, wherein the top portion comprises a sheet having a top surface opposing a bottom surface, wherein the top surface of the sheet has a plurality of bodies extending vertically from the surface of the sheet, and wherein the bodies and surface of the sheet define a pattern matching the texture surface.

10. The patch of claim 8, wherein the bottom surface of the sheet is attached to the top surface of the backing with an adhesive.

11. The patch of claim 9, wherein the bottom surface of the sheet is attached to the backing with an adhesive.

12. A patch for repairing a textured surface comprising:
a backing for receiving a top portion, wherein the backing has a top surface opposing a bottom surface, wherein the top portion comprises a plurality of bodies attached to and extending perpendicularly from the top surface of the backing,
wherein the plurality of bodies and top surface of the backing define a pattern matching the textured surface;
a pressure sensitive adhesive layer deposited on the bottom surface of the backing; and,
a removably attached liner covering the adhesive layer.

13. The patch of claim 12, wherein the bodies are substantially spherically and popcorn shaped.

14. The patch of claim 13, wherein the bodies are formed from polystyrene.

15. The patch of claim 14, wherein the top portion is attached to the backing with adhesive.

16. A method of making a patch for repairing a textured surface comprising:
depositing a pressure sensitive adhesive layer onto a bottom surface of a backing, wherein a top surface of the backing opposes the bottom surface.
covering the adhesive on the bottom surface of backing with a removably attachable liner; and,
attaching a top portion to the top surface of the backing with adhesive.

17. The method of claim 16, wherein the top portion comprises a plurality of bodies extending perpendicularly from the top surface of the backing, and wherein the plurality of bodies and top surface of the backing define a pattern matching the textured surface, and wherein the bodies are substantially spherically and popcorn shaped and are formed from polystyrene.

18. The method of claim 16, wherein the top portion comprises a sheet having a top surface opposing a bottom surface, wherein the top surface of the sheet has a graphical design, wherein the design defines a pattern matching the textured surface.

19. The method of claim 16, wherein the top portion comprises a sheet having a top surface opposing a bottom surface, wherein the top surface of the sheet has a plurality of bodies extending perpendicularly from the top surface, and wherein the plurality of bodies and top surface of the sheet define a pattern matching the textured surface.

20. The method of claim 19, wherein the bodies are substantially spherically and popcorn shaped and are formed from polystyrene.
